(19) United States
(12) Patent Application Publication
(10) Pub. No.: US 2009/0231748 A1
(43) Pub. Date: Sep. 17, 2009

(54) MAGNETIC RECORDING MEDIUM, APPARATUS AND METHOD FOR RECORDING REFERENCE SIGNAL IN THE SAME

(75) Inventor: Kenji Noma, Tsukuba (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/472,032

(22) Filed: May 26, 2009

Related U.S. Application Data
(63) Continuation of application No. PCT/JP2006/323850, filed on Nov. 29, 2006.

(51) Int. Cl. G11B 21/02; B05D 5/12; G11B 5/127; G11B 5/02

(52) U.S. Cl. 360/59; 427/127; 29/603.03; 360/75; G9B/5.04; G9B/5.026; G9B/21.003

(57) ABSTRACT

A method for manufacturing a magnetic recording medium having a recording area includes the steps of forming in the recording area a conductive area that includes a plurality of sectors each made of a conductive magnetic body and is partitioned by a nonmagnetic insulator, and recording a reference signal in all of the plurality of sectors by continuously injecting into the conductive area spin-polarized current having a magnetization pattern corresponding to the reference signal so as to sequentially move a domain wall in the conductive area, an injecting position of the spin-polarized current being fixed while the reference signal being recorded in the plurality of sectors, the reference signal being used for a head to confirm a position on the recording area, the head being configured to record information in the recording area and to reproduce the information from the recording area.

This application is a continuation based on International Application No. PCT/JP2006/323850.

### BACKGROUND OF THE INVENTION

1. Field of the Invention

The present invention relates generally to a manufacturing method of a magnetic recording medium, and more particularly to a method and apparatus configured to record a reference signal in the magnetic recording medium. The present invention is suitable, for example, for a method and apparatus configured to record a servo signal in a magnetic disc having discontinuing magnetic films in a recording layer, such as a discrete track medium (“DTM”) and a patterned medium (“PM”).

2. Description of the Related Art

Along with the recent demand for large capacity, it is proposed to use of a DTM and a PM for a magnetic disc mounted in a hard disc drive (“HDD”). The magnetic disc is partitioned into a multiplicity of concentric tracks, and each track has a multiplicity of sectors that are partitioned for every preset angle. Both the DTM and PM reduce or remove magnetic transition areas that cause noises by partitioning adjacent tracks and/or sectors with a nonmagnetic material. As a result, the recording density can be improved by improving the signal quality.

The magnetic disc needs to record a reference information signal of a recording position for user data (which will also be simply referred to as a “servo signal” hereinafter). The servo signal contains address information and burst information. The address information is information indicative of an address of a track and a sector. A position corresponding to the track/sector of a magnetic head can be roughly recognized based on the address information. The burst information includes a predetermined patterned row, and provides a deviation (positional shift) between the magnetic head and the corresponding track/sector. Since the servo signal is thus used for positioning of the magnetic head, it is necessary to record the servo signal precisely.

Prior art include Patent Reference 1 (U.S. Pat. No. 6,834,005), Patent Reference 2 (Japanese Patent Laid-Open No. 2004-134079 (see, in particular, claims 3-6, and 9, paragraphs nos. 0012 and 0013)), and Literature Reference 1 (A. Yamaguchi, et al., “Real-Space Observation of Current-Driven Domain Wall Motion in Submicron Magnetic Wires,” Physical Review Letters, Vol. 92, No. 7, 20 Feb. 2004, The American Physical Society (2004)).

Prior art use a clock head that is a dedicated servo-signal writing head separate from a magnetic head mounted in the HDD. However, a core width of the magnetic head has become as fine as or finer than 0.2 μm, and it becomes difficult to maintain the precision of the core width of the clock head. On the other hand, there are proposed a push-pin method that uses the magnetic head itself to write the servo signal and a magnetic transfer method that simultaneously transfers a data area and a servo area from a master medium. However, these methods have technical problems and have difficulties in stably and precisely recording a servo signal.

### SUMMARY OF THE INVENTION

The present invention provides an apparatus and method for precisely recording a reference signal in a magnetic recording medium, and a magnetic recording medium in which the reference signal has been written down.

A magnetic recording medium according to one aspect of the present invention includes a reference signal recording area used for a magnetic recording and reproducing head to confirm a position on the magnetic recording medium, the reference signal recording area including a conductive member that enables a reference signal to be written using a domain wall movement caused by a current conduction, and a nonconductive member that encloses the reference signal recording area. This magnetic recording medium can record the reference signal in the entire reference signal recording area simultaneously.

The magnetic recording medium may further include a magnetic recording area that is magnetically divided for each track by a nonmagnetic member. This DTM and PM structures are suitable for the magnetic recording medium of the present invention.

A part of the track may serve as the reference signal recording area, and electric conductivity exists between the track and a center of the magnetic recording medium. In this case, the current conduction direction is a radial direction. A part of the track may have a circumferential shape and serves as the reference signal recording area, wherein a part of a circumference of the reference signal recording area may include a nonconductive member, and wherein the magnetic recording medium further comprises a pair of electrodes at both parts of the conductive member of the reference signal recording area which contact the nonconductive member, and a reference signal may be written using a domain wall movement caused by electrifying both the electrodes. This structure uses the electrodes to record the reference signal in the entire reference signal recording area simultaneously rather than for each track. The magnetic recording area may be magnetically divided for each sector by a nonmagnetic member. The present invention is applicable to this PM structure. The reference signal recording area may be a servo area, and wherein the magnetic recording medium may further includes a pair of electrodes provided to an outer circumference and an inner circumference of the servo area, and a reference signal may be written using a domain wall movement caused by electrifying both the electrodes.

A reference signal recording apparatus according to another aspect of the present invention is configured to write a reference signal in the above magnetic recording medium, and includes a reference signal generator configured to generate the reference signal, and a contact part that contacts the reference signal recording area, the reference signal using a domain wall movement being written by electrifying the contact part. This recording apparatus can write down the reference using the domain wall movement.

A reference signal recording method for writing a reference signal in the above magnetic recording medium according to another aspect of the present invention includes a reference signal generating step of generating the reference signal, a contact step of contacting the reference signal recording area, and a writing step of writing the reference signal using a domain wall movement caused by electrifying a contact point on the reference signal recording area. This recording method can write down the reference using the domain wall movement.

A method for manufacturing a magnetic recording medium that includes a conductive magnetic body as a recording layer partitioned by a nonmagnetic insulator includes the step of recording a servo signal by injecting into the magnetic body spin-polarized current having an inversion pattern corresponding to a servo signal used to position a head that is configured to record information in the magnetic recording medium and to reproduce the information from the magnetic recording medium. This method can manufacture the servo signal using the spin-polarized current.

The method may further include the step of rotating the magnetic recording medium, wherein the recording step injects the spin-polarized current perpendicular to a surface of the magnetic recording medium using a tunneling current probe in synchronization with a target position on the magnetic recording medium, or the recording step may inject the spin-polarized current into a current conduction path along a surface of the magnetic recording medium by using a domain wall movement.

The method may further include the step of forming an electrode to flow the spin-polarized current in the limited servo area. This structure can flow the spin-polarized current in the entire servo area simultaneously rather than for each track. The method may further include the step of heating the magnetic recording medium during the injecting step. This structure can reduce the current density of the spin-polarized current.

The method may further include the steps of forming on the magnetic body by a film formation apparatus a sacrifice layer configured to prevent an oxidization of the magnetic body, moving the magnetic recording medium from the film formation apparatus to a recording apparatus configured to record a servo signal, moving the magnetic recording medium from the recording apparatus to the film formation apparatus after the recording apparatus executes the injecting step, and removing the sacrifice layer by the film formation apparatus. The sacrifice layer can prevent an oxidation of the magnetic body. The method can further include the step of forming a protective layer and a lubrication layer on the magnetic body after the injecting step. Since the protective layer and the lubrication layer are electric insulators and therefore layered afterwards, the servo signal can be recorded on the recording layer.

A recording apparatus according to another aspect of the present invention is configured to record a servo signal used to position on a magnetic recording medium, a head that is configured to record information in and reproduce the information from the magnetic recording medium. The magnetic recording medium includes a conductive magnetic body as a recording layer partitioned by a nonmagnetic insulator. The recording apparatus includes an electrifier/modulator configured to generate and output spin-polarized current having an inversion pattern corresponding to the servo signal. This recording apparatus uses the electrifier/modulator to generate and output the spin-polarized current, realizing the above recording method. This recording apparatus may further include a tunneling current probe configured to inject the spin-polarized current. Thereby, the spin-polarized current can be injected perpendicular or parallel to the surface of the magnetic recording medium.

A magnetic recording medium according to another aspect of the present invention includes a conductive magnetic body as a recording layer partitioned by a nonmagnetic insulator. This magnetic recording medium has a nonmagnetic insulator, and can secure a channel of the spin-polarized current.

For example, the magnetic recording medium is a discrete track medium, and the nonmagnetic insulator is arranged between adjacent tracks. Alternatively, the magnetic recording medium may be a patterned medium, and the nonmagnetic insulator is arranged between adjacent tracks, wherein magnetic bodies may be discretely arranged on the same track and have bit shapes, and a nonmagnetic conductor may be arranged between magnetic bodies having bit shapes on the same track. Moreover, the magnetic recording medium may be a patterned medium, and magnetic bodies may be discretely arranged on the same track and have bit shapes, wherein the nonmagnetic insulator may extend in a radial direction and arranged between adjacent magnetic bodies having bit shapes on the same track, and a nonmagnetic conductor may be arranged between the adjacent magnetic bodies having the bit shape which are aligned with each other in the radial direction between adjacent tracks.

Preferably, the nonmagnetic insulator has an ion milling speed lower than that of the magnetic body. Thereby, the amount of the necessary nonmagnetic insulator to be removed by the ion milling can be reduced. The magnetic recording medium may be a patterned medium in which each magnetic body has preferably an aspect ratio of 1 so as to improve the recording density.

The magnetic body may have an insulation part adjacent to a start position from which the spin-polarized current is injected. This structure can restrict a direction in which the spin-polarized current flows.

A magnetic storage including the above magnetic recording medium also constitutes one aspect of the present invention.

Further features of the present invention will become apparent from the following description of exemplary embodiments with reference to the attached drawings.

### BRIEF DESCRIPTION OF THE DRAWINGS

FIG. 1 is a schematic plane view of a magnetic disc having a servo area.

FIG. 2 is a flowchart for explaining a servo signal recording method according to a first embodiment of the present invention.

FIG. 3 is a schematic block diagram of a servo signal recording apparatus according to the first embodiment.

FIG. 4 is a schematic view of a recording method according to the first embodiment.

FIG. 5 is a schematic sectional view for explaining a flow of the tunneling current in the first embodiment.

FIG. 6 is a flow chart for explaining a servo signal recording method according to a second embodiment of the present invention.

FIG. 7 is a schematic block diagram of a servo signal recording apparatus according to the second embodiment.

FIG. 8 is a schematic view of a recording method according to the second embodiment.

FIG. 9 is a schematic view for explaining a domain wall movement by current injections.

FIG. 10 is an enlarged plane view of three adjacent tracks in a DTM applicable to the second embodiment.

FIG. 11 is an enlarged plane view of three adjacent tracks in a PM applicable to the second embodiment.

FIG. 12 is an enlarged plane view of three adjacent tracks in another PM applicable to the second embodiment.

FIG. 13 is a schematic sectional view for explaining a flow of the tunneling current in the second embodiment.

FIG. 14 is a flowchart for explaining a manufacturing method of a DTM usable for the first and second embodiments.

FIG. 15A to FIG. 15F are schematic sectional views of the DTM corresponding to each step of FIG. 14.

FIG. 16 is a flowchart for explaining a manufacturing method of a PM usable for the first and second embodiments.

FIG. 17 is a schematic plane view of a magnetic disc of a DTM applicable to a third embodiment.

FIG. 18 is a flowchart for explaining a servo signal recording method according to the third embodiment of the present invention.

FIG. 19 is a schematic block diagram of the servo signal recording apparatus according to the third embodiment.

FIG. 20A and FIG. 20B are schematic block diagrams for explaining a layered structure of a magnetic recording medium having an insulation layer.

FIG. 21 is a plane view of an HDD having a magnetic disc in which the servo signal has been written down.

### DESCRIPTION OF THE EMBODIMENTS

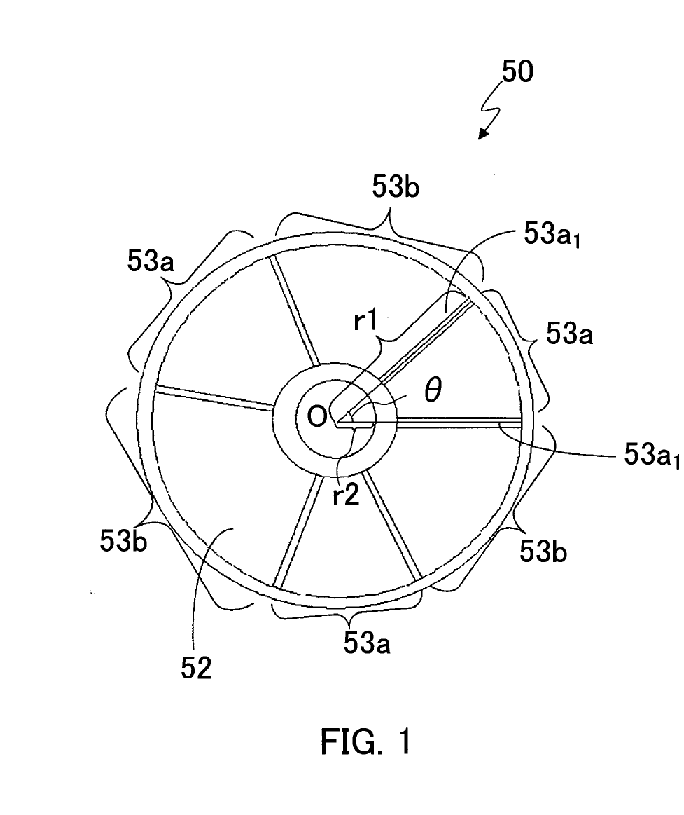

FIG. 1 is a schematic plane view of a magnetic disc 50. A recording surface (or surface) 52 of the magnetic disc 50 is divided into a plurality of servo areas 53a and a plurality of user data areas 53b. The number of servo areas 52a and their intervals, and a central angle of each servo area 53a are not limited to the structure shown in FIG. 1, but the respective servo areas 53a have the same shape, and are distributed around a center O of the magnetic disc 50 at regular intervals in this embodiment. The servo area 53a is defined by a pair of nonmagnetic insulators 53a₁, each of which extends in a radial direction and, for example, is an area made by removing a fan area having a central angle θ and a radius r2 from a fan area having the same central angle θ and a radius r1.

A recording method and apparatus of this embodiment are a recording method and apparatus for recording a servo signal in the servo area 53a. In writing the servo signal, a phenomenon of the magnetization inversion induced by the spin-polarized current injection is used, which is a phenomenon in which a magnetization direction of a magnetic body changes due to a spin-torque interaction when the spin-polarized current is flowed in the magnetic body. By inverting the polarity of the spin-polarized current, the magnetization direction of the magnetic body can be arbitrarily determined. When an inversion pattern of the spin-polarized current is made identical to the servo signal pattern, the servo signal can be more precisely recorded than the clock head and the magnetic transfer method.

This embodiment is particularly suitable for the DTM and PM that are magnetic recording media using discontinuing magnetic films for a magnetic layer, because they have recording densities which the conventional clock head cannot handle. It is said that the magnetization inversion by the spin-torque requires the current density in the order of 10⁶ A/cm², but an application of the current with the above density is easy if the track width of about 0.1 μm in the DTM and PM. In order to reduce the current density, the disc may be heated while the spin-polarized current is injected. Heating facilitates the magnetization inversion.

Since the DTM or PM has no electrode through which the current is injected, a spin-polarized current flowing means is necessary. It is also necessary to define a current conduction channel through which the spin-polarized current flows. When the current conduction channel is not defined, the spin-polarized current spreads and a servo signal is recorded beyond the servo area.

### First Embodiment

A first embodiment uses a conductive magnetic layer in the servo area 53a so as to flow the spin-polarized current in a recording layer (magnetic body) to be recorded with a servo signal.

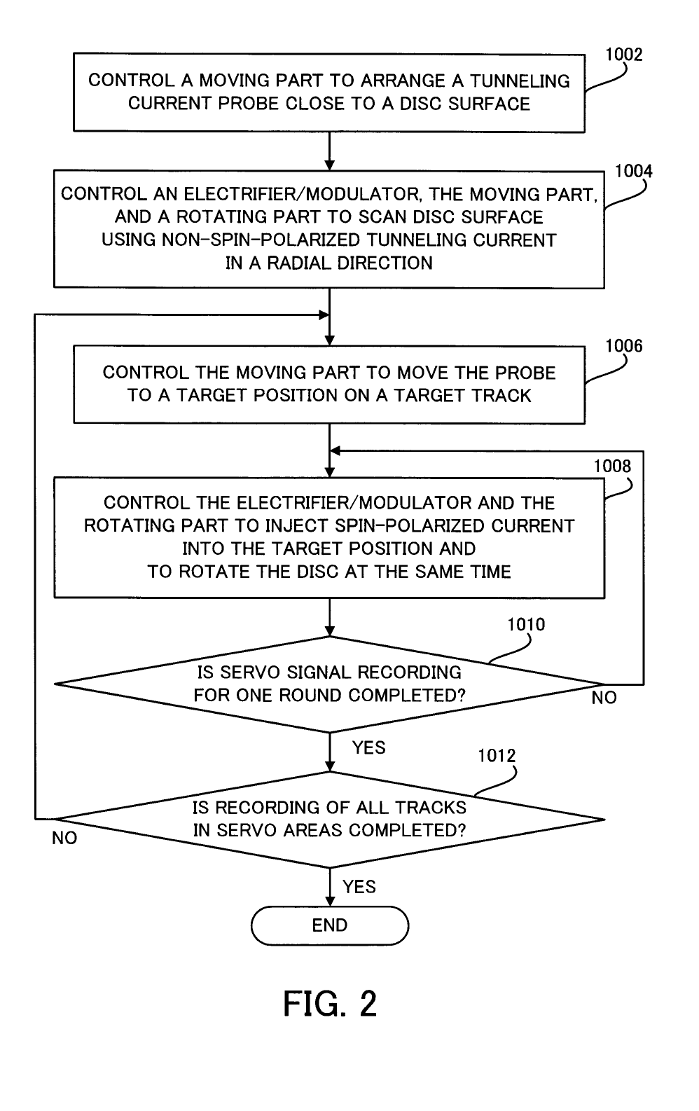

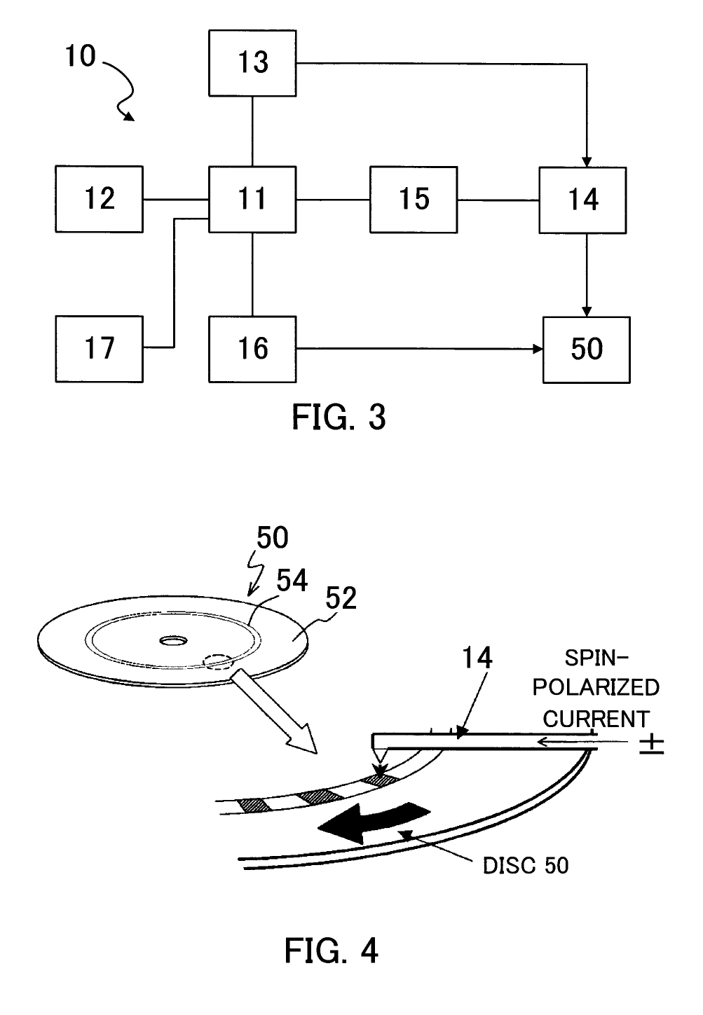

FIG. 2 is a flowchart for explaining a servo signal recording method according to a first embodiment. FIG. 3 is a schematic block diagram of a servo signal recording apparatus 10 according to a first embodiment. Referring to FIG. 3 the recording apparatus 10 includes a controller 11, a memory 12, an electrifier/modulator 13, a tunneling current probe 14, a probe moving part 15, a rotating part 16 for a magnetic disc 50, and a heater 17.

The controller 11 controls each part, such as the memory 12, the electrifier/modulator 13, and the moving part 15, and may be a CPU or MPU irrespective of its name. Information stored in the memory 12 contains a structure of the disc 50, a recording method shown in FIG. 2, and a variety of data. The structure of the magnetic disc 50 contains a type of the magnetic disc 50 (DTM or PM), a direction of an axis of easy magnetization in the magnetic disc 50 (whether it is parallel or perpendicular to a surface), an arrangement of the servo areas 53a and the user data areas 53b, and information of the servo signal. A variety of data contains a scanning result and rotation information of the disc 50. The controller 11 refers to the memory 12, and controls the electrifier/modulator 13 so that the inversion pattern corresponds to the servo signal pattern.

The electrifier/modulator 13 outputs from the probe 14 the spin-polarized current having an inversion pattern corresponding to a given servo signal or a modulation pattern in the polarized direction, under the control of the controller 11. In addition, the electrifier/modulator 13 can flow the non-spin-polarized current (which will also be referred to as “normal current” in this embodiment), or stop outputting the current. The normal current cannot provide a function of the magnetization inversion. The controller 11 controls the timing and turning on and off of an output of the electrifier/modulator 13.

The electrifier/modulator 13 can modulate the current by applying an external magnetic field, by irradiating a circularly polarized light, or by using a semiconductor device.

In applying the external magnetic field, part of the probe 14 is made of a ferromagnetic material, and an external coil is wound so as to cross the probe current that flows in this part. When the tunneling current is flowed while an AC signal corresponding to the servo signal pattern is applied to the coil, the polarization direction of the electronic spin changes according to changes of the external magnetic field.

In using the circularly polarized light, the tunneling current is flowed while the polarization direction of the laser beam irradiated onto the tip of the probe 14 is changed according to the servo signal pattern. Thereby, the electronic spin-polarized direction in the tunneling current changes according to changes of the polarized light direction of the laser beam.

In using the semiconductor device, a CMOS device that uses a magnetic semiconductor doped with a magnetic element, such as manganese and chrome. For example, a device that uses a magnetic semiconductor for a source of the p-channel MOS and a device that uses a magnetic semiconductor for a drain of the n-channel MOS are arranged (although reverse polarities are applicable), and an AC signal is applied to both gates in accordance with the servo signal pattern. Thereby, the electronic spin-polarized direction of the drain current switches according to the AC signal.

The tunneling current probe 14 is widely used as a means for analyzing a fine structure of a material surface, and the probe moving part 15 can move the probe 14 with precision of ±0.1 μm. It is easy to position the probe at the track having a width of 0.1 μm in the DTM or PM. The controller 11 controls the probe moving part 15 so that the probe 14 can move to a target track in the servo area.

The rotating part 16 includes a spindle that rotates the disc 50, and a motor (not shown) that rotates the spindle. In an alternate embodiment, the rotating part 16 is a spindle motor 106 mounted on the HDD 100. The magnetic disc 50 in which the servo signal is recorded becomes a magnetic disc 104, which will be described later. The conventional method that uses a clock head writes a servo signal in the HDD 100, whereas the recording apparatus 10 is different from the conventional recording apparatus in having the rotating part 16, although the other embodiment of the present invention allows the rotating part 16 to be the spindle motor mounted in the HDD 100.

The heater 17 heats the disc 50. The heater 17 may be attached to a spindle or may heat the disc 50 from the top. As described above, when the disc 50 is heated, the magnetization inversion is likely to occur even with low electric density.

In operation shown in FIG. 2 of the recording apparatus 10, the magnetic disc 50 is initially mounted on the rotating part 16 of the HDD 100 or the HDD 100 mounted with the magnetic disc 50 is prepared. Of course, the present invention allows the recording apparatus 10 to have the independent rotating part 16.

Next, the controller 11 controls the moving part 15 to arrange the tunneling current probe 14 close to the disc surface 52 (step 1002). A distance of the close arrangement differs according to the environments of the disc 50, but the close arrangement intends to exclude the contact. As described later, the disc 50 rotates and the probe 14 or the disc 50 may get damaged when the probe 14 contacts the disc 50. When the servo signal is written down in vacuum, the close arrangement is within a distance of several tens of nanometers from the surface 52. When the servo signal is written down in vacuum, the close arrangement is within a distance of several nanometers from the surface 52.

Next, the controller 11 controls the electrifier/modulator 13, the moving part 15, and rotating part 16 to scan the disc surface 52 using the non-spin-polarized tunneling current in the radial direction (step 1004). The scan uses, for example, a scanning tunneling microscope “STM” system. Then, a magnetic track part and a nonmagnetic part can be recognized as contrasts of the conductive part and the nonconductive part, as shown in FIGS. 10 to 12, which will be described later. The scanning result is stored in the memory 12.

In case of a DTM, the scan is a raster scan in which the probe 14 is moved from the center of the disc 50 to the outer circumference in the radial direction and then returned to the center. In this case, rotating of the disc 50 during scanning is unnecessary.

On the other hand, the scan of a PM associates with a rotation of the disc 50 in this embodiment. The disc 50 is not necessarily rotated in order to detect the tracks. Whether the rotation is necessary depends upon the bit pattern of the magnetic bodies. When the bit width is shorter on the inner circumference side and longer on the outer circumference side, the bits are aligned in the radial direction and thus the disc 50 may be maintained stationary, similar to the DTM. On the other hand, when the number of bits on the inner circumference side is smaller and the number of bits on the outer circumference side is larger, the bits shift in the radial direction and the disc 50 needs to rotate. This embodiment detects not only the tracks but also the recording start position of the servo signal through scanning. This embodiment sets a recording start position of the servo signal for the PM. In this embodiment, the recording start position is detected by deforming a bit shape of a top sector, and by detecting the deformed shape through scanning. Therefore, the disc 50 needs to be rotated.

Next, the controller 11 controls the moving part 15 by referring to the scanning result in the memory 12 (or by feeding back the scanning result) to move the probe 14 to a target position of a target track 54 (step 1006). A target position on a certain track is an arbitrary position in the DTM, but it is necessary to align the target positions with each other the radial direction between the adjacent tracks. As a result, the target positions on the respective tracks are aligned with each other in the radial direction. In the PM, the probe is moved to the preset recording start position.

Since the conventional recording method using the clock head has no positioning clue on the disc surface 52, the positioning accuracy is limited to the mechanical precision. On the other hand, this embodiment can improve the positioning precision through the feedback utilizing the electric conduction difference on the disc surface 52.

Next, the controller 11 controls the electrifier/modulator 13 and the rotating part 16 to inject the spin-polarized current to the target position and to rotate the disc 50 at the same time. At this time, as necessity arises, the controller 11 controls the heater 17 to heat the disc 50. The number of rotations of the disc 50 depends upon the writing frequency into the servo area 53a, and sets to the number of rotations or lower used for the recording and reproducing time in the HDD 100.

FIG. 4 shows a schematic view of the step 1008. As shown in FIG. 4, the spin-polarized current is applied to the probe 14 and injected into the track 54 on the disc 50 after the probe 14 is positioned to the same sector as the adjacent track, and the disc 50 is simultaneously rotated. Thereby, a magnetization pattern corresponding to the servo signal can be recorded on the target track 54.

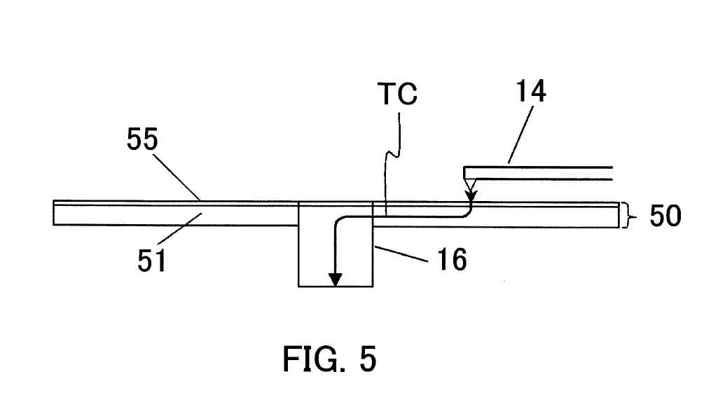

FIG. 5 is a schematic sectional view showing the flow of the tunneling current in the steps 1004 and 1008. The tunneling current passes the disc 50 from the probe 14 to the spindle (the rotating part 16). Therefore, in the first embodiment, the tunneling current flows perpendicular to the disc surface 52. Since the spin-polarized current flows perpendicular to the recording layer (magnetic body) 55, the domain wall movement in the surface is negligible. Even when the tunneling current flows on the disc surface 52, the direction of the axis of easy magnetization is not necessarily perpendicular to the surface 52 and it may be parallel to the surface. Whether it is parallel or perpendicular to the surface depends upon the anisotropy of the orientation control layer. In FIG. 5, reference numeral 51 denotes a substrate or a conductive layer on the substrate. TC denotes the tunneling current.

In the step 1008, the controller 11 provides on/off control so that the electrifier/modulator 13 flows the current in the servo area 53a shown in FIG. 1 and does not flow the current (or flows the normal current) in the user data area 53b.

Next, the controller 11 determines whether writing of servo signals into a plurality of servo areas 53a on the track 54 for one round is completed (step 1010). The controller 11 continues the step 1008 until recording of the servo signals for one round is completed. Of course, in the step 1010, the controller 11 may rotate the disc 50 for 360° or terminate the rotation when the last servo area 53a in the rotating direction is completed. The latter case, for example, is a case where recording starts with the right servo area 53a and ends with the upper-left servo area 53a in FIG. 1.

Next, the controller 11 refers to the memory 12, and determines whether the servo signals have been recorded in all the tracks in the servo areas (step 1012). The scanning result performed in the step 1004 is stored in the memory 12. Determining that all the servo signals are recorded (step 1012), the controller 11 terminates the recording action. When the controller 11 determines that all the servo signals have not yet been recorded (step 1012), the flow returns to the step 1006.

### Second Embodiment

Since it is necessary to flow the spin-polarized current in the recording layer (magnetic body) to be recorded with the servo signal in the servo area 53a, the second embodiment uses a conductive magnetic layer in principle but also provides an insulator 56.

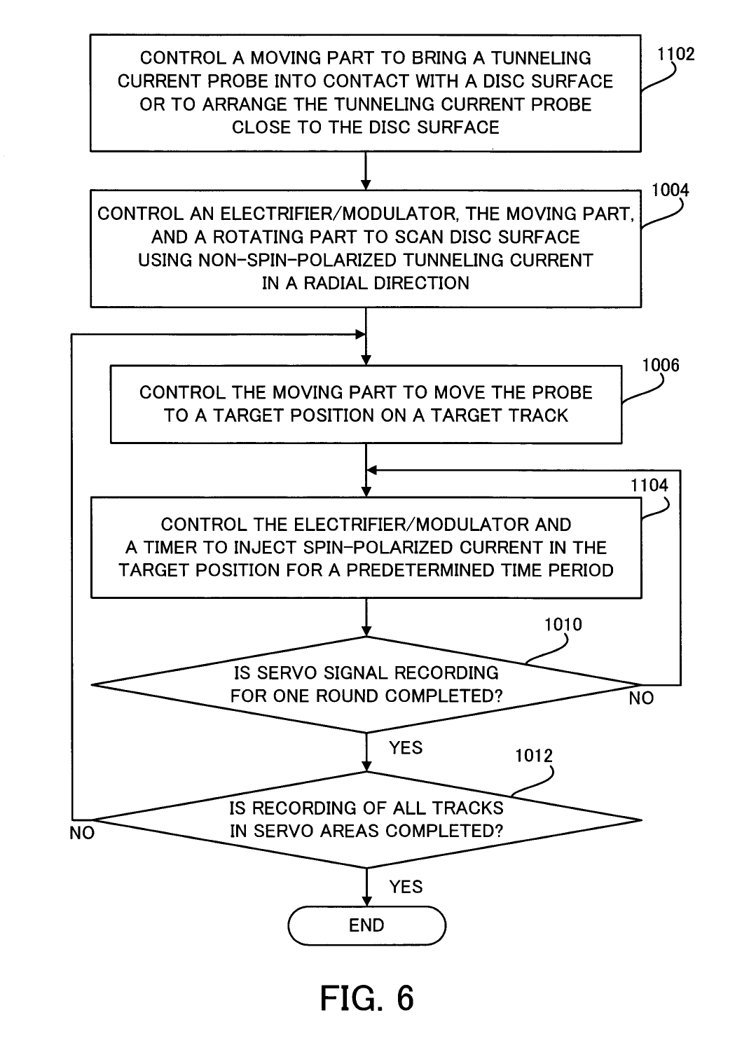

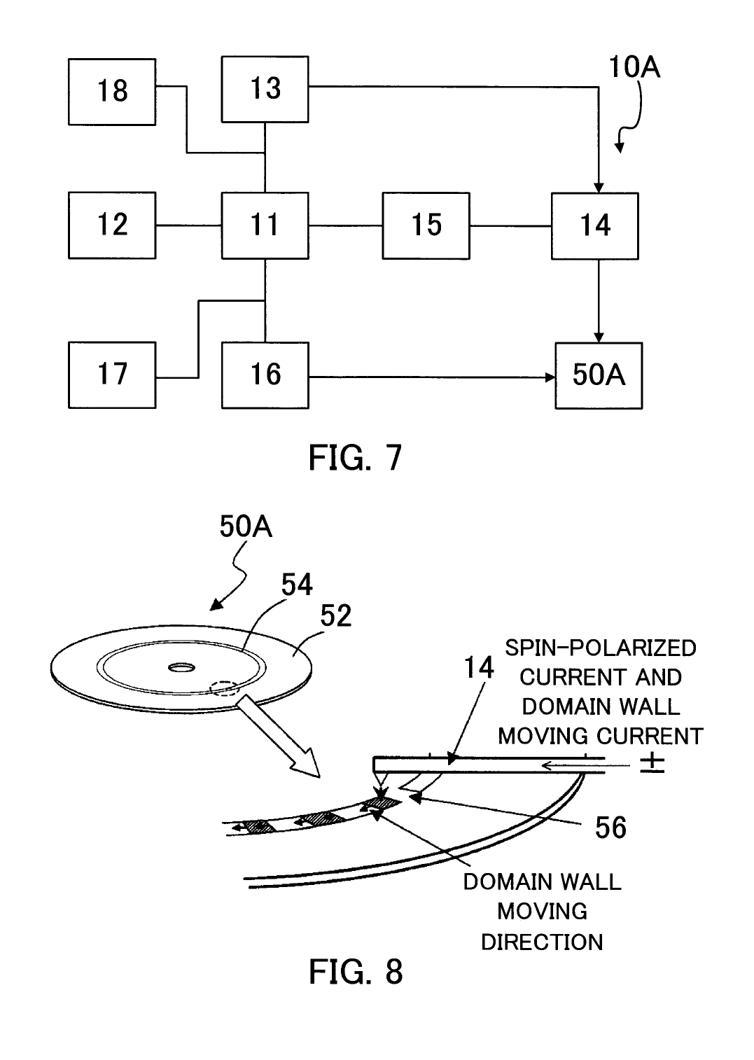

The second embodiment is common to the first embodiment in injecting the spin-polarized current and in writing the servo signal, but different from the first embodiment in using the recording method shown in FIG. 6, the recording apparatus 10A shown in FIG. 7, and the magnetic disc 50A. The recording apparatus 10A shown in FIG. 7A is different in further including a timer 18 connected to the controller 11 and configured to measure a time period. Here, FIG. 6 is a flowchart for explaining a servo signal recording method according to a second embodiment. FIG. 7 is a schematic block diagram of the recording apparatus 10A according to the second embodiment.

The magnetic disc 50A is different from the magnetic disc 50 in having an insulator 56 in a specific sector. In FIG. 8, the domain wall moving direction is clockwise, and the insulator 56 prevents the domain wall moving direction from changing to the counterclockwise direction. Therefore, the insulator 56 is arranged adjacent to the starting point of the spin-polarized current injection. The second embodiment forms the insulator 56 by embedding an insulation material into the specific sector on the track of the disc 50A.

Referring now to FIG. 6, an operation of the recording apparatus 10A will be described. Those elements in FIG. 6, which are the same as corresponding steps as those in FIG. 2, will be designated by the same reference numerals, and a description thereof will be omitted. Similar to FIG. 2, the magnetic disc 50A is initially mounted on the rotating part 16. Next, the controller 11 controls the moving part 15 to arrange the tunneling current probe 14 close to or bring it into contact with the disc surface 52 (step 1102). The step 1102 is different from the step 1002 in that the probe 14 can be brought into contact with the disc surface 52. The close arrangement in the step 1102 is the same concept as that in the step 1002. The contact is allowed because the disc 50 is not rotated, but the close arrangement is more preferable than the contact so as not to damage the probe 14 and the disc 50.

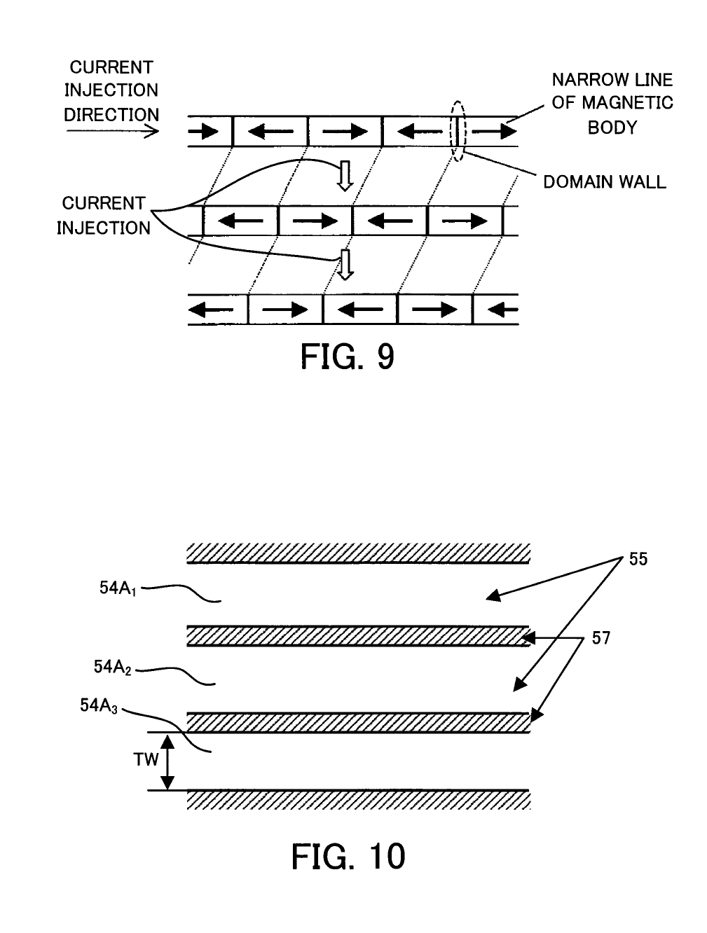

After the steps 1004 and 1006, the controller 11 controls the electrifier/modulator 13 and the timer 18 to inject the spin-polarized current into the target position for a predetermined time period. FIG. 8 shows a schematic view of the step 1102. The second embodiment sequentially supplies the magnetic pattern through the domain wall movement by applying the spin-polarized current. The insulator 56 prevents a reverse flow of the spin-polarized current in FIG. 8. The controller 11 controls the electrification by the electrifier/modulator 13 by measuring a necessary time period using the timer 18 for the domain wall movement. It is known that when an inversion pattern of the spin-polarized current is continuously injected as shown in FIG. 9, domain walls of the magnetic bodies sequentially move, and a magnetization pattern having an arbitrary bit length can be formed according to injected pulse lengths. See, for example, Literature Reference 1.

In the DTM, each magnetic body 55 has an annular pattern along each track 54 and is generally electrically conductive, as shown in FIG. 10. The tunneling current flows in the track direction or disc circumferential direction, and the domain wall can move. Here, FIG. 10 is an enlarged plane view of adjacent three tracks 54A₁ to 54A₃ on the DTM. Each track has a track width TW, which is about 0.1 μm. Since a nonmagnetic insulator 57 is arranged between the two adjacent tracks and eliminates a magnetic transition area, the DTM can improve the signal quality. The insulator 56 is omitted in FIG. 10.

On the other hand, the PM has a dot pattern of electrically conductive magnetic bodies 55. At this state, no domain wall movement can be achieved because the tunneling current flows only in the dot and does not flow in the track direction.

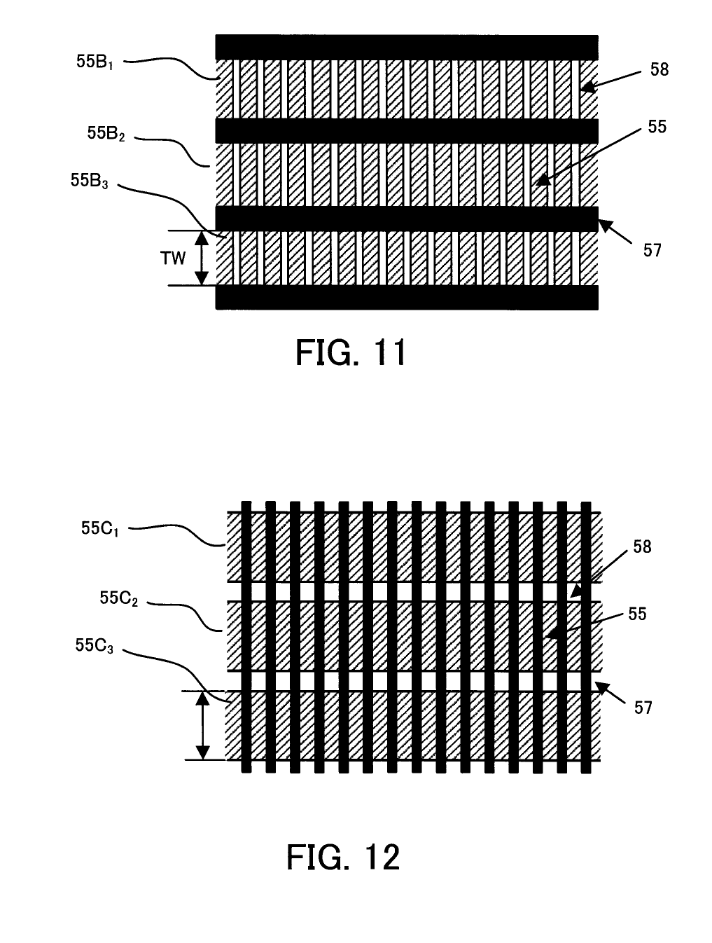

Accordingly, as shown in FIG. 11, a nonmagnetic insulator 57 is arranged between the two adjacent tracks, and a nonmagnetic conductor 58 is arranged between two consecutive dots in each track. Thereby, the tunneling current can flow in the circumferential or track direction, realizing the domain wall movement.

Alternatively, as shown in FIG. 12, the nonmagnetic conductor 58 may be arranged between the magnetic bodies in the radial direction rather than the circumferential direction, and the nonmagnetic insulator 57 may be arranged between the two adjacent magnetic bodies 55 in the track direction. Thereby, the dots in the adjacent tracks are connected to each other via the conductive material, and the tunneling current flows in a radial direction or a direction perpendicular to the track direction, realizing the domain wall movement.

Here, FIG. 11 or 12 is an enlarged plane view of three adjacent tracks 54B₁ to 54B₃ or 54C₁ to 54C₃ in the PM. Each track has a track width TW, which is about 0.1 μm. Since the nonmagnetic body 57 or 58 between two adjacent tracks eliminates a magnetic transition area, the PM can improve the signal quality. While FIGS. 11 and 12 makes a bit length corresponding to a lateral width of each bit smaller than the track width TW corresponding to a longitudinal width of each bit, the recording density can be preferably increased by setting an aspect ratio to 1.

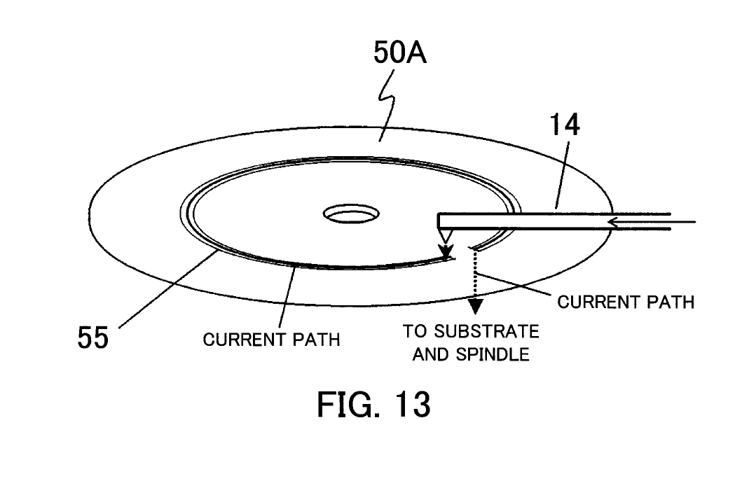

FIG. 13 is a schematic sectional view showing the flow of the tunneling current in the step 1104. The tunneling current passes through the disc 50A from the probe 14 to the rotating part 16. It is understood that the tunneling current flows along the surface of the disc surface 52 in the second embodiment. Although the tunneling current flows over approximately one round in FIG. 13 for illustration convenience, the tunneling current actually flows only in the preset servo area 53a as shown in FIG. 1.

Turning back to FIG. 6, the steps 1010 and 1012 are executed.

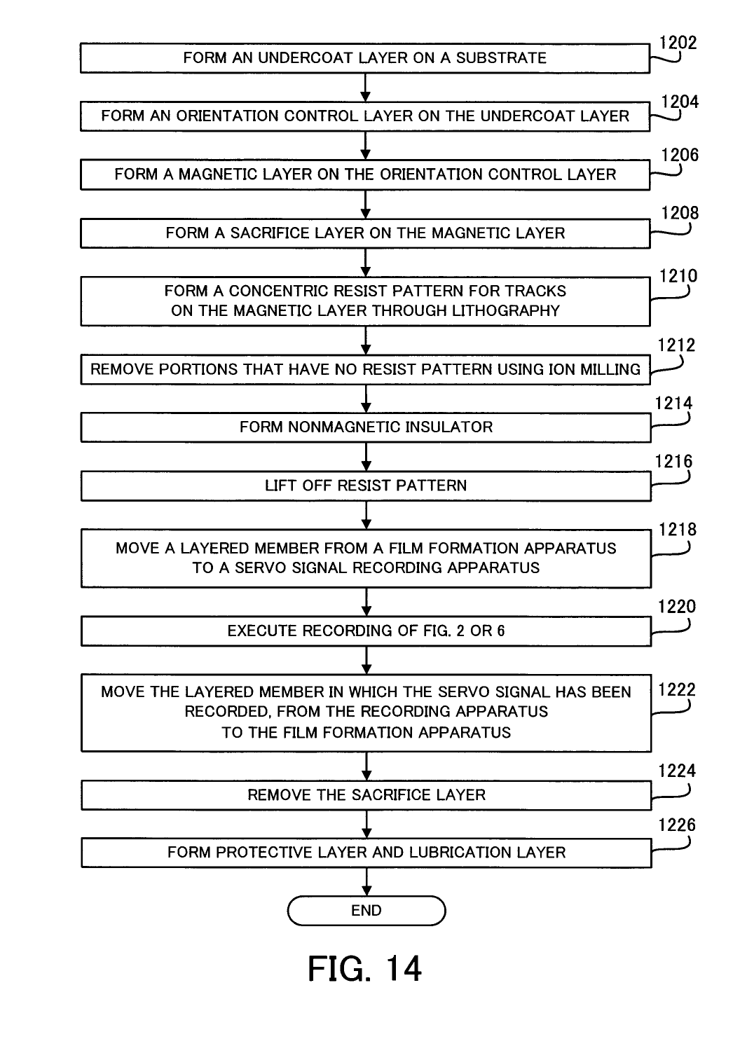

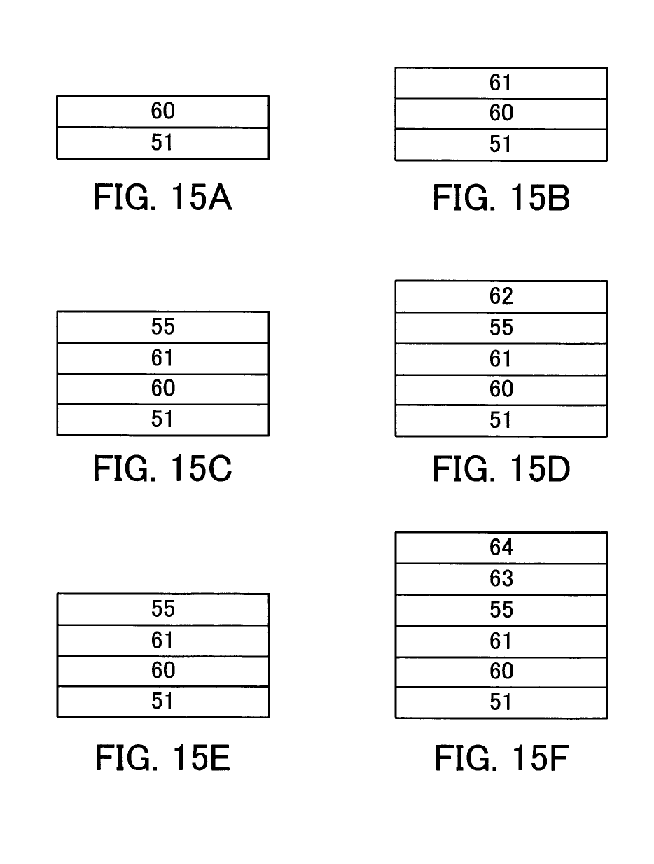

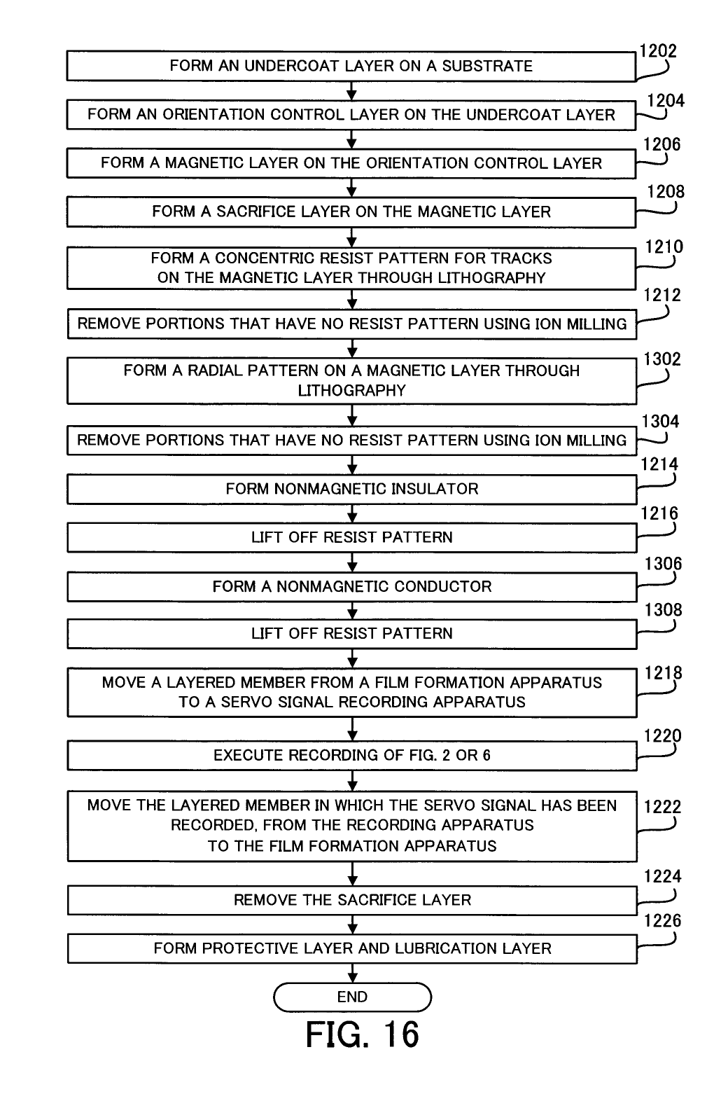

Referring now to FIGS. 14 and 15A to 15F, a description will be given of a manufacturing method of a DTM usable for the first and second embodiments. Here, FIG. 14 is a flowchart for explaining a manufacturing method of a DTM usable for the first and second embodiment. FIGS. 15A to 15F are schematic sectional views of each manufacturing step of the DTM. This manufacturing method utilizes a film formation apparatus (not shown).

Initially, as shown in FIG. 15A, an undercoat layer 60 made of Ni alloy, etc., and configured to maintain the strength of the film is formed on a substrate 51 made of a material, such as glass or aluminum (step 1202). The undercoat layer 60 may use a different material according to the anisotropy of an orientation control layer 61. In FIG. 5, the undercoat layer, etc. are omitted.

Next, as shown in FIG. 15B, the orientation control layer 61 configured to control the anisotropy is coated on the undercoat layer 60 (step 1204). For example, the orientation control layer 61 uses Cr alloy in order to orient the direction of the axis of easy magnetization along the disc surface 52 (or for the in-plane or parallel magnetization), and Ru or its alloy in order to direct the axis of easy magnetization perpendicular to the disc surface 52 (or for the perpendicular magnetization).

Next, as shown in FIG. 15C, a thin conductive magnetic body (recording layer) 55 is coated on the orientation control layer 61. The magnetic body 55 is made, for example, of CoCr (step 1206).

Next, as shown in FIG. 15D, in order to prevent oxidization of the magnetic body 55, an electrically conductive sacrifice layer 62 is coated (step 1208). The sacrifice layer 62 is made by coating, for example, Ru or Au on the magnetic body 55 by several nanometers. Coating of the sacrifice layer 62 does not conventionally exist. However, an application of the sacrifice layer 62 becomes optional if the recording apparatus 10 or 10A is maintained in vacuum and connected to the film formation apparatus via a load lock mechanism and the magnetic body 55 is unlikely to oxidize.

Next, a resist pattern for the tracks is concentrically formed on the magnetic body 55 through the lithography (step 1210). This photography step has not yet been conventionally provided and can precisely form a track pattern, removing the unevenness on the disc surface 52. When grooves among tracks are formed by mechanical processing, such as cutting, rather than photolithography, the disc surface 52 becomes uneven and is likely to collide with the probe 14 during scanning. In addition, it is substantially difficult to form the insulator 56 without the photolithography. When a specific sector position on each track is covered with a resist pattern through the photolithography, the magnetic disc 50A having the insulator 56 can be formed.

Next, a pattern having no resist pattern is removed through ion milling (step 1212). Next, a nonmagnetic insulator is formed through sputtering (step 1214), and the resist pattern is lifted off (step 1216). Thereby, a model of the DTM is completed.

Next, the laminated member is moved from the film formation apparatus to the recording apparatus 10 or 10A (step 1218). In this case, the sacrifice layer 62 prevents the oxidation of the magnetic body 55. Next follows the servo signal recording process shown in FIG. 2 or 6 (step 1220).

Next, the laminated member in which the servo signal has been recorded is moved from the recording apparatus 10 or 10A to the film formation apparatus (step 1222). Next, as shown in FIG. 15E, the sacrifice layer 62 is removed through sputtering etc. (step 1224). The step 1224 has not yet been conventionally provided. Next, as shown in FIG. 15F, a protective layer 63 and a lubrication layer 64 are formed on the magnetic body 55 (step 1226). The protective layer 63 is made, for example, of a diamond like carbon, and the lubrication layer 64 is made of an organic solvent, such as Tetraol.

Thus, in this embodiment, before the protective layer 63 and the lubrication layer 64 are layered, the servo signal can be written in the state of the magnetic body 55 or in the state of the magnetic body 55 coated with the sacrifice layer 62. This is because the protective layer 63 and the lubrication layer 64 are made of insulation materials and do not flow the spin-polarized current. On the other hand, since the conventional clock head writing is performed after the protective layer 63 and the lubrication layer 64 are layered, the steps 1220 and 1226 are different from the conventional steps.

Referring now to FIG. 16, a description will be given of a manufacturing method of a PM usable for the first and second embodiments. Here, FIG. 16 is a flowchart for explaining a manufacturing method of a PM usable for the first and second embodiments. Those steps in FIG. 16, which are the same as corresponding steps in FIG. 14, will be designated by the same reference numerals, and a duplicate description thereof will be omitted.

In FIG. 16, after the step 1212, a radial resist pattern is again formed through the photolithography (step 1302). Next, a pattern having no resist pattern is removed through ion milling (step 1304). The magnetic body 55 having a bit shape is formed by the steps 1210, 1212, 1302, and 1304.

At this time, part of the nonmagnetic insulator 57 that is not covered with the resist pattern is removed through ion milling, and thus the nonmagnetic insulator 57 is preferably made of alumina or tantalum pentoxide, etc. having an ion milling rate lower than that of the magnetic body 55.

After the ion milling, the nonmagnetic conductor 58 is formed through electrolysis plating (step 1306), and the resist pattern is lifted off (step 1308). The electrolysis plating does not form a layer of the nonmagnetic conductor 58 on the nonmagnetic insulator 57, and the nonmagnetic conductor 58 is embedded only at part from which the magnetic body 55 is removed by the ion milling. Thereby, the model of the PM shown in FIG. 11 is completed. The subsequent steps are similar to those for the DTM.

The PM shown in FIG. 12 forms a radial resist pattern through a first lithography, and an annular resist pattern through a second lithography. In other words, the steps 1210 and 1302 in FIG. 16 will be replaced.

### Third Embodiment

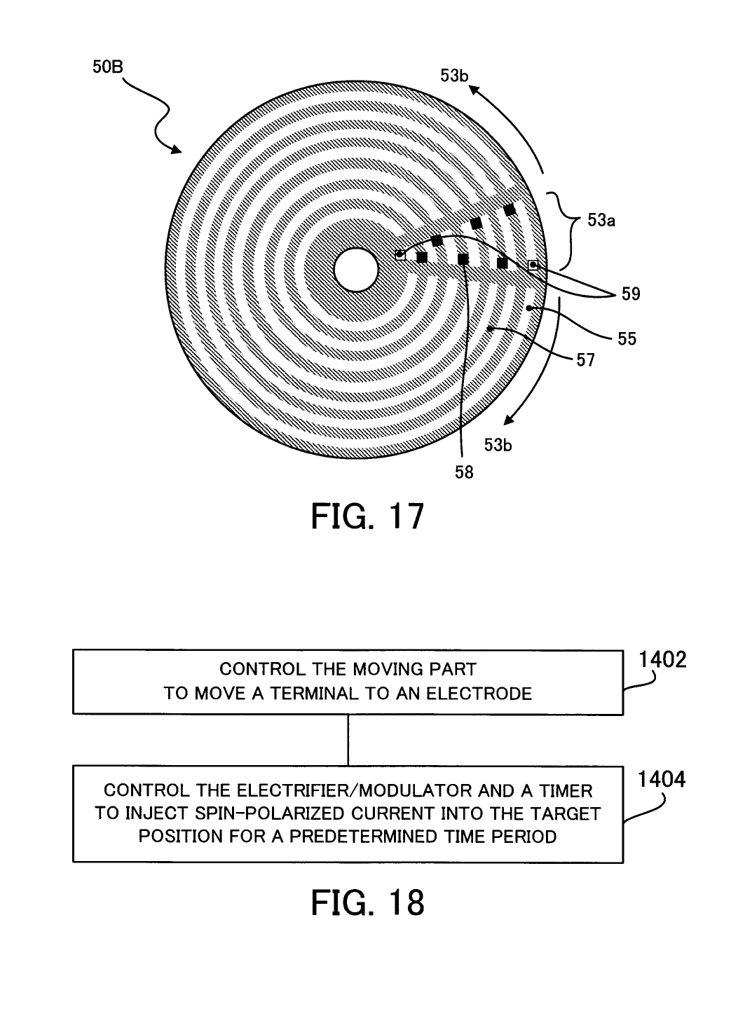

The third embodiment forms a pair of electrodes 59 on the magnetic disc 50B through fine processing, as shown in FIG. 17, which is a plane view of the magnetic disc 50B as the DTM. FIG. 17 sets the servo area 53a to a constant angle range and the user data area 53b to the remaining part for convenience.

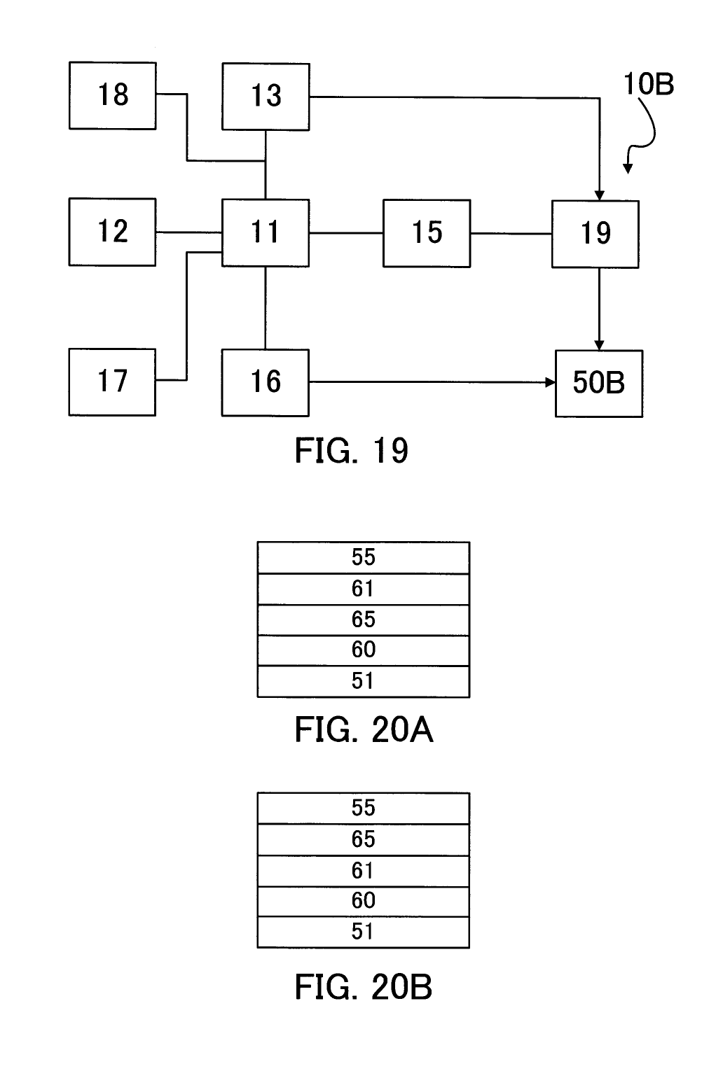

As shown in FIG. 17, the third embodiment adds a conductive wiring pattern to the laminated member of the disc 50B, and connects the magnetic bodies (tracks or dots) 57 to each other. Thereby, the recording apparatus used for the third embodiment uses a pair of plus and minus terminals 19 instead of the tunneling current probe 14 as shown in FIG. 19. The pin-polarized current is injected via the terminals. The recording method is as shown in FIG. 18. Here, FIG. 18 is a flowchart for explaining a servo signal recording method of the third embodiment. FIG. 19 is a schematic block diagram of a recording apparatus 10B of the third embodiment.

Referring to FIG. 18, the controller 11 controls the moving part 15 to move the terminals 19 to the terminals 59 (step 1402), and controls the electrifier/modulator and the timer to inject the spin polarized current into the electrodes 59 for a predetermined time period (step 1404). The third embodiment does not need the scanning step 1004 to flow the spin-polarized current to the whole servo area simultaneously, and allows the protective layer 63 and the lubrication layer 64 to be layered on the magnetic body 55 as long as the electrodes 59 exposes.

A description will be given of a manufacturing method of a DTM and a PM used for the third embodiment. Basic steps are similar to those of the first and second embodiments. However, in case of the DTM, the insulator 56 or the nonmagnetic insulator 53a1 is initially embedded into a specific sector position on each track. Next, a resist pattern is formed through the photolithography so as to expose part that serially connects the tracks and parts of the prospective electrodes 59. After ion milling, the nonmagnetic conductor 58 is formed through the electrolysis plating, the resist pattern is lifted off, and the protective layer 63 and the lubrication layer 64 are layered. The spin-polarized current is flowed from the completed electrodes 59. Since the electrodes 59 become unnecessary after the servo signal is written, they may be removed through etching but may be left. In removing through the etching, the sacrifice layer 62 is formed after the electrodes 59 are formed on the magnetic body 55, and then the servo signal is written down. Thereafter, similar to the steps 1222 and 1224, the sacrifice layer 62 is removed, and the protective layer 63 and the lubrication layer 64 are layered similar to the step 1226.

In the step 1404, the spin-polarized current may not flow parallel to the surface 52 and may flow perpendicular to the surface 52 towards the rotating part 16. Therefore, it is preferable to arrange the insulation layer. The insulation layer 65 may be arranged on the undercoat layer 60 as shown in FIG. 20A or just under the magnetic body 55 as shown in FIG. 20B. Of course, the protective layer 63 and the lubrication layer 64 may be layered on the magnetic body 55.

### Fourth Embodiment

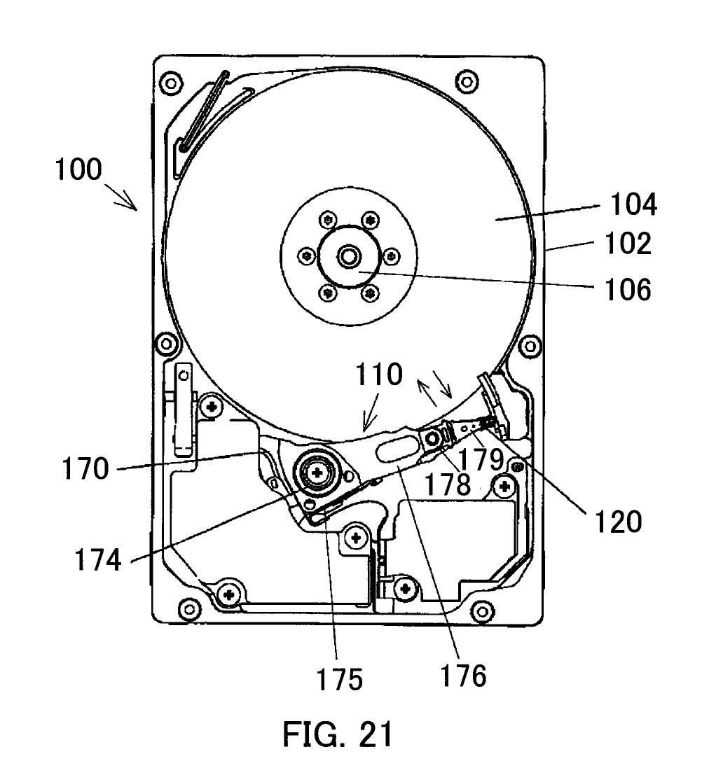

Referring now to FIG. 21, a description will be given of the HDD 100 having a magnetic disc in which a servo signal has been written down. The HDD 100 includes, as shown in FIG. 21, one or more magnetic discs 104 as recording media, a spindle motor 106, a head stack assembly (“HSA”) 110 in a housing 102. Here, FIG. 21 is a schematic plane view of an internal structure of the HDD 100.

The housing 21 is made, for example, of aluminum die casting or stainless steel, and has a rectangular parallelepiped shape, and is coupled with a cover (not shown) to shield the internal space. The magnetic disc 104 can be any one of the above magnetic discs 50 to 50B in which the servo signal is recorded, and has a high surface recording density. The magnetic disc 104 is mounted on a spindle (hub) of the spindle motor 106 via holes that are provided at the center.

The spindle motor 106 has, for example, a brushless DC motor (not shown) and a spindle as a rotor part. In using two discs 104, for example, the disc, a spacer, the disc, a clamp ring are mounted in this order around the spindle, and these discs are fixed by bolts fastened with the spindle.

The HSA 110 includes a magnetic head part 120, a carriage 170, a base plate 178, and a suspension 179.

The magnetic head part 120 includes a slider and a read/write head joined with an air outflow end of the slider.

The slider supports the head, and floats over the surface of the rotating disc 104. The head records information in and reproduces information from the disc 104. A surface of the slider that opposes to the magnetic disc 104 serves as a floating surface. The airflow that is generated based on the rotations of the magnetic disc 104 is received by the floating surface.

The head is a magnetoresistive (“MR”) inductive composite head that includes an inductive head device that writes binary information in the magnetic disc 104 utilizing the magnetic field generated by a conductive coil pattern (not shown), and a MR head that reads the binary information based on the resistance that varies in accordance with the magnetic field applied by the magnetic disc 104.

The carriage 170 serves to rotate or swing the magnetic head part 120 in arrow directions shown in FIG. 21, and includes a voice coil motor (not shown), a support shaft 174, a flexible printed circuit board (“FPC”) 175, and an arm 176.

The voice coil motor has a flat coil between a pair of yokes. The flat coil opposes to a magnetic circuit (not shown) provided to the housing 102, and the carriage 170 swings around the support shaft 174 in accordance with values of the current that flows through the flat coil. The magnetic circuit includes, for example, a permanent magnet fixed onto an iron plate fixed in the housing 102, and a movable magnet fixed onto the carriage 170.

The support shaft 174 is inserted into a hollow cylinder in the carriage 170, and extends perpendicular to the paper surface of FIG. 21 in the housing 102. The FPC 175 provides a wiring part with a control signal, a signal to be recorded in the disc 104, and the power, and receives a signal reproduced from the disc 104.

The arm 176 has a perforation hole at its top. The suspension 179 is attached to the arm 176 via the perforation hole and the base plate 178. The base plate 178 serves to attach the suspension 179 to the arm 176. A welded portion is laser-welded with the suspension 179, and a dent is swaged with the arm 176.

The suspension 179 serves to support the magnetic head part 120 and to apply an elastic force to the magnetic head part 120 against the disc 104. The suspension 179 has a flexure (also referred to as a gimbal spring or another name) which cantilevers the magnetic head part 120, and a load beam (also referred to as a load arm or another name) which is connected to the base plate 178. The load beam has a spring part at its center so as to apply a sufficient compression force in a Z direction.

In operation of the HDD 100, the spindle motor 106 rotates the disc 104. The airflow associated with the rotation of the disc 104 is introduced between the disc 104 and slider, forming a fine air film. This air film generates the floating force that enables the slider to float over the disc surface. The suspension 179 applies an elastic compression force to the slider in a direction opposing to the floating force of the slider. As a result, the balance is formed between the floating force and the elastic force.

The above balance spaces the magnetic head part 120 from the disc 104 by a constant distance. Next, the carriage 170 is rotated around the support shaft 174 for head's seek for a target track on the disc 104. Since the servo signal is precisely written, the seek precision improves. In writing, data from a host (not shown) such as a PC is received through the interface and modulated, and written down in the target track via the inductive head. In reading, the MR head device is supplied with predetermined sense current, and reads desired information from the desired track on the disc 104.

The present invention enables the servo signal precisely to be written down even in a DTM, a PM, or a magnetic disc 104 having a recording density of 2-3 Tbits/in2 or higher whereas the conventional method has a difficulty in so doing.

Further, the invention is not limited to the disclosed exemplary embodiments, and various modifications and variations may be made.

What is claimed is:

1. A method for manufacturing a magnetic recording medium having a recording area, said method comprising the steps of:
forming in the recording area a conductive area that includes a plurality of sectors each made of a conductive magnetic body and is partitioned by a nonmagnetic insulator; and
recording a reference signal in all of the plurality of sectors by continuously injecting into the conductive area spin-polarized current having a magnetization pattern corresponding to the reference signal so as to sequentially move a domain wall in the conductive area, an injecting position of the spin-polarized current being fixed while the reference signal being recorded in the plurality of sectors, the reference signal being used for a head to confirm a position on the recording area, the head being configured to record information in the recording area and to reproduce the information from the recording area.

2. The method according to claim 1, wherein the nonmagnetic insulator magnetically divides the recording area for each track.

3. The method according to claim 1, further comprising the step of forming a pair of electrodes at both ends of the conductive area, the recording step injecting the spin-polarized current via the pair of electrodes.

4. The method according to claim 1, further comprising the step of arranging between a substrate and a recording layer that forms the recording area, an insulation layer configured to facilitate the spin-polarized current to flow along a surface of the recording layer.

5. The method according to claim 1, wherein the recording area is magnetically divided for each sector,
wherein the nonmagnetic insulator is arranged among the plurality of sectors, and configured to separate the plurality of sectors in one of a circumferential direction and a radial direction of the recording area, and
wherein the conductive area further includes a nonmagnetic conductor arranged among the plurality of sectors, and configured to electrically connect the plurality of sectors to one another in the other of the circumferential direction and the radial direction of the recording area.

6. The method according to claim 1, further comprising the steps of:
forming by a film formation apparatus a sacrifice layer configured to prevent an oxidization of the recording area;
moving the magnetic recording medium from the film formation apparatus to a recording apparatus configured to record the reference signal;
moving the magnetic recording medium to the film formation apparatus after the recording apparatus executes the recording step; and
removing the sacrifice layer by the film formation apparatus.

7. The method according to claim 1, further comprising the step of heating the magnetic recording medium during the recording step.

8. A recording apparatus configured to record a reference signal in a conductive area of a magnetic recording medium that includes a recording area, the conductive area that includes a plurality of sectors each made of a conductive magnetic body and is partitioned by a nonmagnetic insulator being formed in the recording area, the reference signal being used for a head to confirm a position on the recording area, the head being configured to record information in the recording area and to reproduce the information from the recording area, said recording apparatus comprising:
a generator configured to generate spin-polarized current having a magnetization pattern corresponding to the reference signal; and
a recorder configured to record all of the plurality of sectors by continuously injecting into the conductive area so as to sequentially move a domain wall in the conductive area, an injecting position of the spin-polarized current being fixed while the reference signal being recorded in the plurality of sectors.

9. A recording method configured to record a reference signal in a conductive area of a magnetic recording medium that includes a recording area, the conductive area that includes a plurality of sectors each made of a conductive magnetic body and is partitioned by a nonmagnetic insulator being formed in the recording area, the reference signal being used for a head to confirm a position on the recording area, the head being configured to record information in the recording area and to reproduce the information from the recording area, said recording method comprising the steps of:
generating spin-polarized current having a magnetization pattern corresponding to the reference signal; and
recording all of the plurality of sectors by continuously injecting into the conductive area so as to sequentially move a domain wall in the conductive area, an injecting position of the spin-polarized current being fixed while the reference signal being recorded in the plurality of sectors.
